(19) United States
(12) Patent Application Publication
(10) Pub. No.: US 2007/0002802 A1
(43) Pub. Date: Jan. 4, 2007

(54) Access ports with directional antennas

(76) Inventor: Ramesh Sekhar, San Jose, CA (US)

Correspondence Address: INGRASSIA FISHER & LORENZ, P.C., 7150 E. CAMELBACK, STE. 325, SCOTTSDALE, AZ, 85251, US

(21) Appl. No.: 11/171,623

(22) Filed: Jun. 30, 2005

(51) Int. Cl. H04Q 7/00

(52) U.S. Cl. 370/334

(57) ABSTRACT

An access port for use in a wireless network having a wireless switch in accordance with an exemplary embodiment of the present invention is provided. The access port includes a transceiver operable to send data based on routing information generated by the wireless switch. An antenna selector couples the transceiver and a plurality of antennas. The antenna selector is configured to selectively couple the transceiver with at least one of the plurality of antennas based at least in part on the routing information.

### TECHNICAL FIELD OF THE INVENTION

This invention relates to the field of wireless networking and, more specifically, to access ports with directional antennas.

### BACKGROUND OF THE INVENTION

In today's work environment, mobile connectivity is becoming increasingly important. The ability to send and receive data anywhere within an office, school, factory or other location is quickly becoming a necessity, and wireless local area networks have been introduced to facilitate such mobile connectivity. Generally, a wireless local area network includes access ports that are directly connected to wired networks, such as an Ethernet network. In this approach, maintaining configuration data, performing client authentication and performing other tasks are conducted at the access port. However, such an approach has numerous deficiencies and drawbacks, including elevated costs for network management and maintenance.

To alleviate some of these deficiencies and drawbacks, a wireless network has been developed that is based on an intelligent wireless switch. In this type of wireless network, access ports are coupled with a wireless switch that contains the intelligence to maintain configuration data, perform client authentication and perform other tasks while the access ports provide only wireless access. This configuration has numerous benefits, including ease of management, cost efficiency, and flexibility.

A potential problem in wireless local area networks is the possibility of interference between two or more transmitting access ports. For example, interference can occur when a radiation pattern produced by an access port's omni-directional antenna interferes with the radiation pattern emitted from other access ports. This situation is illustrated in FIG. 1, where a first access port 102 is attempting to communicate with a second access port 104 and a third access port 106 is attempting to communicate with a fourth access port 108. Because the first access port 102 uses an omni-directional antenna, a first antenna radiation pattern 101 extends outward in a generally circular pattern towards the second access port 104. A third antenna radiation pattern 103 similarly extends outward from the third access port 106 towards the fourth access port 108. The first antenna radiation pattern 101, which was intended for second access port 104, also propagates towards the fourth access port 108 and the first antenna radiation pattern 101 and the third antenna radiation pattern 103 can intersect each other near the fourth access port 108, causing possible interference and the potential inability of the fourth access port 108 to receive the communications from the second access port 104. This interference can occur whether the access ports are wired or wireless access ports.

Accordingly, it is desirable to provide a wireless network system with wireless access ports that reduces, substantially eliminates or totally eliminates interference from overlapping radiation patterns. In addition, it is desirable to provide methods for transmitting signals in a wireless network system with wireless access ports that substantially eliminates or totally eliminates interference from overlapping radiation patterns. Furthermore, the other desirable factors and characteristics of the present invention will become apparent from the subsequent detailed description and the appended claims, taken in conjunction with the accompanying drawings, technical field and background.

### BRIEF DESCRIPTION OF THE DRAWINGS

The present invention will hereinafter be described in conjunction with the following drawing figures, wherein like numerals denote like elements, and:

FIG. 1 illustrates interference between two transmitting access ports;

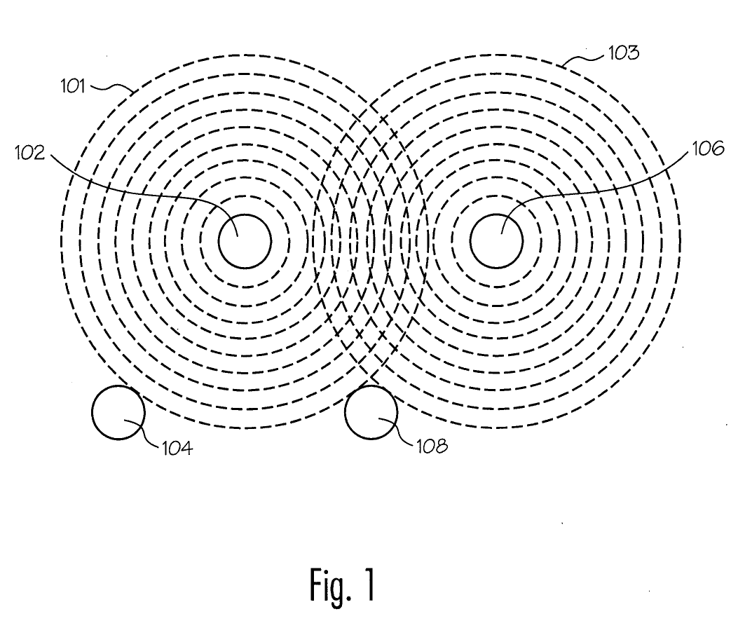

FIG. 2 illustrates a wireless network in accordance with an exemplary embodiment;

FIG. 3 illustrates a wireless access port in accordance with an exemplary embodiment;

FIG. 4 illustrates two access ports that are transmitting with minimized interference in accordance with an exemplary embodiment; and

FIG. 5 is a flowchart illustrating a method for locating a mobile unit in accordance with an exemplary embodiment of the present invention.

### SUMMARY OF THE INVENTION

In an exemplary embodiment of the present invention, an access port for use in a wireless network having a wireless switch is provided. The access port includes a transceiver operable to send data based on routing information generated by the wireless switch. An antenna selector couples the transceiver and a plurality of antennas. The antenna selector is configured to selectively couple the transceiver with at least one of the plurality of antennas based at least in part on the routing information.

In another exemplary embodiment of the present invention, a method is provided for sending a signal from an access port used in a wireless network that includes a wireless switch. First, routing information is received from the wireless switch indicating a destination for the signal. Then, a first antenna selected from a plurality of directional antennas of the access port to use to send the signal is determined. The first antenna is coupled to a transceiver of the access port through an antenna switch. The signal is sent using the first antenna.

### DETAILED DESCRIPTION OF THE DRAWINGS

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

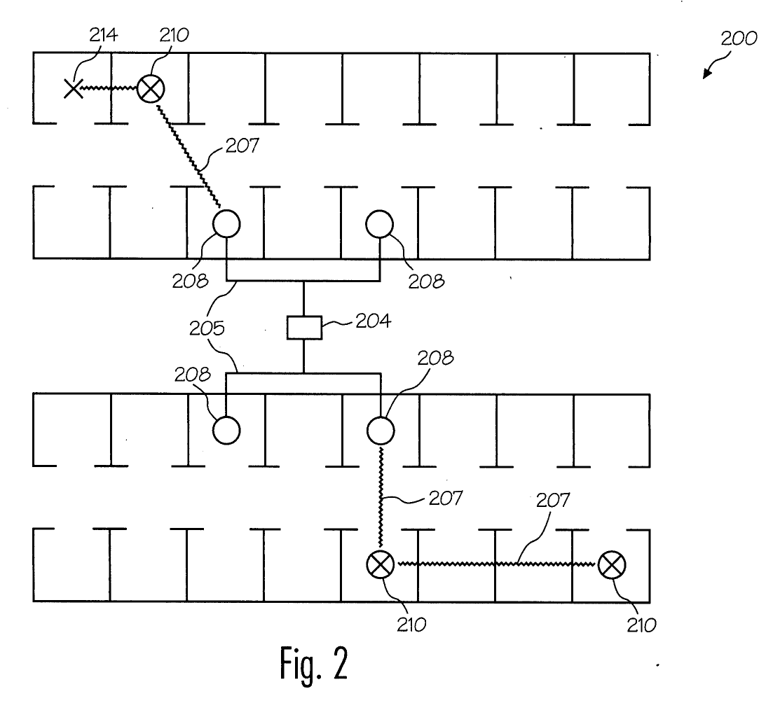

FIG. 2 illustrates an exemplary wireless local area network 200 distributed throughout a floor of a building, facility or other location. The wireless local area network 200 includes a wireless switch 204 coupled to wired access ports 208. The wireless local area network also includes wireless access ports 210 that are configured to communicate with the wired access ports 208. The wireless local area network 200 further includes mobile units 214 that can communicate between each other as well as with other devices in the wireless local area network 200 and with devices outside the local area network 200.

Wireless switch 204 is configured to provide centralized management and intelligence for the wireless local area network 200. The wireless switch 204 can determine optimal routing paths for data transfer in the wireless local area network 200 and provide the routing information to the wired access port 208 and the wireless access port 210. Wireless switch 204 is also configured to distribute software and software updates to the wired access ports 208 and the wired access ports 208 can send the software and software updates to the wireless access ports 210. In one embodiment wireless switch 204 couples the wireless local area network 200 to an external network such as the Internet.

Wired access ports 208 connect to the wireless switch 204 via a wired connection 205 that provides data transfer between the wired access ports 208 and the wireless switch 204. Additionally, the wired connection 205 can supply power to the wired access ports 208. Wired access ports 208 are further configured to send and receive data from mobile units 214 and wireless access ports 210. Routing information for the wired access port 208 can be determined, at least in part, at the wireless switch 204.

Wireless access ports 210 are configured to communicate with mobile units 214 and wired access ports 208 over a wireless link 207. The wireless access ports 210 utilize routing information provided by the wireless switch 204 to help determine where to send data. Unlike the wired access ports 208, the wireless access ports 210 are not connected to the wireless switch 204 via the wired connection 205 and communicate with the wireless switch 204 via the wired access ports 208.

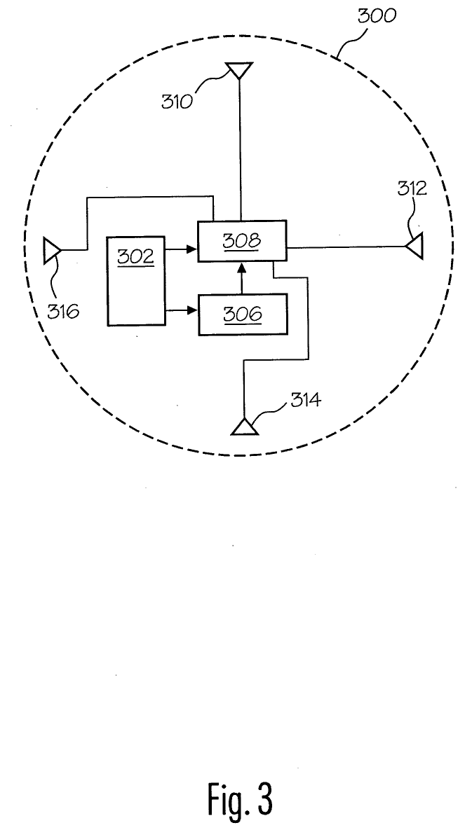

An access port 300 is illustrated in FIG. 3 in accordance with an exemplary embodiment of the invention. The access port 300 illustrated in FIG. 3 is a wireless access port, although access port 300 can also be a wired access port. A wired transceiver (not shown) would be provided if access port 300 was a wired access port in order to enable communication between the access port 300 and the wireless switch 204. Access port 300 comprises a processor 302 coupled to a transceiver 306. Antennas 310-316 couple to the transceiver 306 and processor 302 via an antenna selector 308.

Transceiver 306 is configured to send and receive transmissions to and from wireless access ports 210, wired access ports 208 and mobile units 214. While FIG. 3 illustrates a combined transceiver 306, separate receiver and transmitter units can also be used in accordance with the present invention.

Processor 302 is configured to execute various programs needed for the operation of the access port 300. For example, processor 302 can be configured to determine the proper antenna 310-316 to use for a transmission.

Antennas 310-316 receive and transmit signals within a given region. In one exemplary embodiment, antennas 310-316 are directional antennas whose radiation patterns are in the form of lobes that extend outward from each of the antenna in one direction for a given antenna position. By placing the antennas around the access port in approximately an evenly spaced pattern, each of the antennas covers a certain portion of a 360 degree arc around the access port 300. In the exemplary embodiment illustrated in FIG. 3, each of the four antennas 310-316 are evenly spaced and transmit and receive data within each of the four antennas' ninety degree area of coverage. While four antennas are shown in FIG. 3, the exact number of antennas can vary depending upon the area of coverage desired for each antenna 310-316.

Antenna selector 308 is configured to couple the transceiver 306 with one or more of the antennas 310-316 for sending and receiving broadcasts. Through the use of the antenna selector 308, the single transceiver 306 can send a signal over any combination of the antennas 310-316. In one exemplary embodiment, processor 302 can determine the antennas to use and can control the antenna selector 308 to select the proper antenna(s). The selection of the proper antenna(s) can be based, at least on part, on routing information supplied by the wireless switch 204. While processor 302 and antenna selector 308 are illustrated as separate elements, the two components can be formed as a single integrated component. In one exemplary embodiment, antenna selector 308 can be implemented as a Field-Programmable Gate Array (FPGA).

To alleviate the possibility of interference from overlapping omni-directional antenna emissions, in one exemplary embodiment of the present invention, the directional antennas 310-316 of the access port 300 can be selectively chosen to avoid interference from neighboring access ports 300. Access port 300 can be a wired or wireless access port. In the embodiment illustrated in FIG. 3, the access port 300 includes four directional antennas 310-316 coupled to the common transceiver 306. The number of directional antennas 310-316 can be varied within the scope of the present invention. Antenna selector 308 can selectively couple the transceiver 306 to one or more of the antennas 310-316 for transmitting a signal, the choice depending at least in part upon the location of the destination access port or mobile unit 214. Alternatively, all four directional antennas 310-316 can be used to simultaneously send a signal that can be used to indicate the access port's proximity to the mobile unit 214. This type of transmission can be referred to as a beacon signal. The selection of the number of antennas to use to send a signal depends upon the application and can vary within the scope of the present invention.

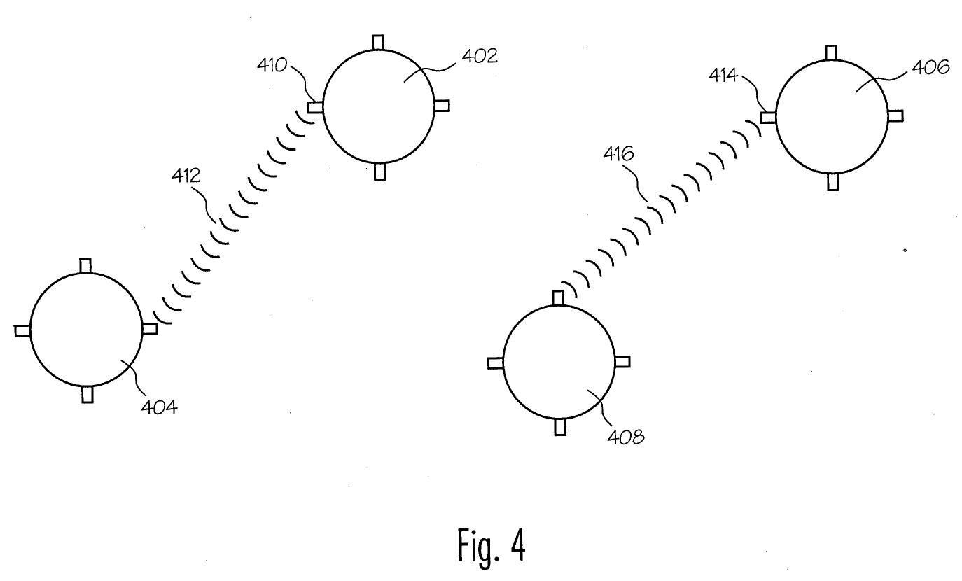

Since antennas 310-316 of access port 300 can send transmissions along an antenna lobe that covers only a portion of the regions encompassed by the radiation pattern produced by a typical omni-directional antenna, interference between access ports can be avoided using this characteristic. Turning to FIG. 4, a first access port 402 is communicating with a second access port 404 using an antenna 410 closest to the second access port 404. Note that a first antenna radiation pattern 412 (i.e. the antenna lobe) for the transmitting antenna 410 of first access port 402 does not extend towards fourth access port 408, and therefore, does not interfere with a third radiation pattern 416 produced by third access port 406. Thus, third access port 406 can communicate with the fourth access port 408 using the antenna 410 closest to the fourth access port 408 without interference from first access port 402.

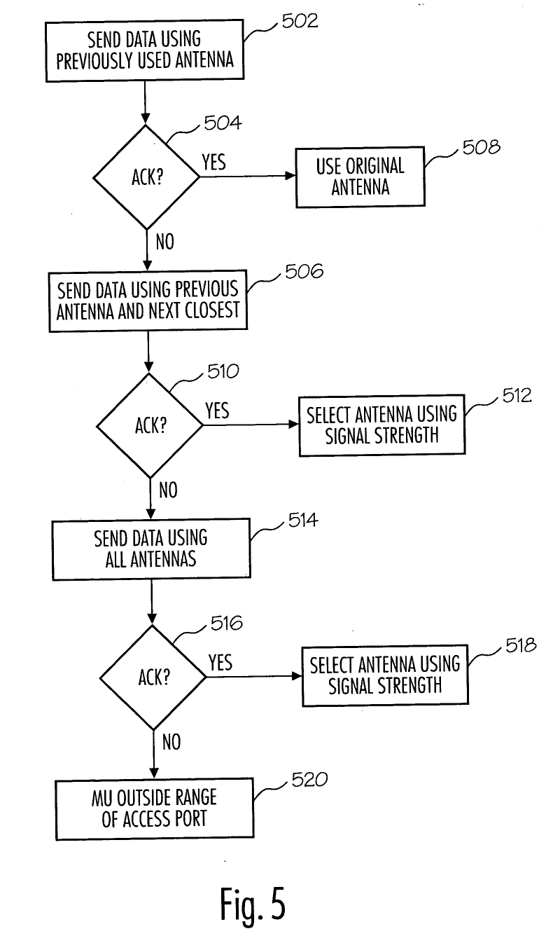

As discussed previously, the exemplary access port 300 as illustrated in FIG. 3 of the present invention can select the appropriate antenna to use when communicating with another access port or mobile unit 214. Since mobile units 214 by their very nature can move, the antenna used to communicate with the mobile unit 214 can change. Therefore, mobile units 214 need to be tracked as the units move from an area covered by one of the antennas 310-316 to another area covered by another of the antennas 310-316 of the same access port. FIG. 5 is a flowchart of an exemplary method 500 for selecting the antenna to use to communicate with a mobile unit. In this exemplary embodiment of the present invention, it is assumed that the access port 300, which can be a wired or wireless access port, has four antennas 310-316. Also, a previous location of the mobile unit 214 and the antenna last used to communicate with the mobile unit 214, referred to herein as the current antenna, is known.

In step 502 of the method 500, data packets are transmitted from the access port 400 using the antenna, such as antenna 310, which is the current antenna. Next, it is determined if an acknowledgement is received from the mobile unit 214 within a set number of attempts, such as three attempts (step 504). If an acknowledgement is received in step 504, antenna 310 is identified as the current antenna to use to contact the mobile unit 214 (step 508).

If no acknowledgement is received after the set number of attempts, the data packets are sent using the current antenna and one or more additional antennas, in step 506. In an exemplary embodiment, antennas adjacent to the current antenna are first selected. In this example, the current antenna is antenna 310 and the two additional antennas adjacent to the current antenna are antenna 312 and antenna 316. Next, in step 510, it is determined if an acknowledgement is received at any of the three antennas within a fixed number of attempts.

If an acknowledgement is received from a mobile unit 214, the acknowledgement may be received by more than one of the antennas 310, 312 and 316. If more than one antenna receives the acknowledgement, the antenna that will be the new current antenna can be selected based on the signal strength of the received signal or some other measure of signal quality in step 512.

If an acknowledgement is not received by any of the antennas, all four antennas 310-316 can be used to send the packet (step 514). It is then determined if an acknowledgement is received at any of the four antennas within a fixed number of attempts (step 516). If an acknowledgement is received, the antenna to use as the new current antenna can be determined based on the received signal strength measured at the antenna 310-316 (step 518). If no acknowledgement is received, then it is assumed that the mobile unit 214 has moved to an area covered by a different access port (step 520).

The method as illustrated in FIG. 5 assumed that there were four antennas. If the number of antennas were different, then in the method additional antennas will be added as broadcasting antennas after each unsuccessful attempt until either a response is received or all antennas have been used without a response. If there is no response after all antennas have been used, the assumption is made that the mobile unit has moved outside the range of the access port.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. An access port for use in a wireless network having a wireless switch comprising:
a transceiver operable to send data based on routing information generated by the wireless switch;
a plurality of antennas; and
an antenna selector coupled between the transceiver and each of the plurality of antennas, the antenna selector configured to selectively couple the transceiver with at least one of the plurality of antennas based at least in part on the routing information.

2. The access port of claim 1 wherein the access port is operable to send data to the wireless switch via a wired access port coupled to the wireless switch by a wired connection.

3. The access port of claim 2 wherein the access port receives power over the wired connection.

4. The access port of claim 1 further comprising a processor coupled to the transceiver and the antenna selector, the processor operable to determine the at least one antenna of the plurality of antennas to couple to the transceiver.

5. The access port of claim 4 wherein the processor is further configured to determine which of the plurality of antennas to use to transmit to a mobile unit.

6. The access port of claim 5 wherein the processor is further configured to track a mobile unit as the mobile unit moves from a first area covered by a first directional antenna of the plurality of antennas to a second area covered by a second directional antenna of the plurality of antennas.

7. The access port of claim 6 wherein the processor is further configured to:
transmit a signal to the mobile unit using a current antenna of the plurality of antennas and wait for a response;
continue to use the current antenna to transmit the signal to the mobile unit if the response is received;
couple one or more additional antennas of the plurality of antennas and the current antenna to the transceiver and send the signal using the additional antennas and the current antenna if no response is received from the mobile unit;
select as the current antenna the antenna that received the signal with the greatest signal strength if a response is received; and
continue to couple additional antennas of the plurality of antennas to the transceiver and send a signal until a response is received and an antenna is determined to be the current antenna, or if all antennas have been used without receiving a response, determining that the mobile unit is out of the range of the antennas.

8. The access port of claim 1 wherein the antenna selector is configured to couple the transmitter to all of the plurality of antennas to broadcast a beacon signal.

9. The access port of claim 1 wherein each of the plurality of antennas are directional antennas.

10. The access port of claim 1 wherein the access port receives software updates from the wireless switch.

11. A method for sending a signal from an access port used in a wireless network that includes a wireless switch comprising:
receiving routing information from the wireless switch indicating a destination for the signal;
determining a first antenna selected from a plurality of directional antennas of the access port to use to send the signal;
coupling the first antenna to a transceiver of the access port through an antenna switch; and
sending the signal using the first antenna.

12. The method of claim 11 wherein the step of coupling the first antenna further comprises coupling all of the plurality of antennas to the transceiver to send a beacon signal.

13. The method of claim 11 further comprising:
transmitting a signal to a mobile unit using a current antenna and waiting for a response;
if the response is received, continuing to use the current antenna;
if no response is received from the mobile unit, coupling additional antennas of the plurality of antennas along with the current antenna to the transceiver and sending the signal using the additional antennas and the current antenna;
if a response is received, selecting as the current antenna the antenna that received the signal with the greatest signal strength; and
if a response is not received, continuing to couple additional antennas of the plurality of antennas to the transceiver and continuing to send a signal until a response is received and one of the pluralities antenna is determined to be the current antenna, or all antennas have been used without receiving the response, which indicates the mobile unit is out of the range of the access port.

14. The method of claim 13 wherein the step of transmitting a signal to the mobile unit using the current antenna and waiting for a response further comprises transmitting the signal a number of times without a response before determining the response has not been received.

15. The method of claim 14 wherein the step of continuing to couple additional antennas further comprises selecting one or more antennas adjacent to the current antenna as the additional antennas.

16. A wireless network comprising:
a plurality of access ports comprising:
a transceiver;
a plurality of antennas;
an antenna selector coupled between the transceiver and each of the plurality of antennas, the antenna selector configured to couple the transceiver with at least one of the plurality of antennas, and
a wireless switch coupled to the plurality of access ports, the wireless switch operable to determine routing information for each of the plurality of access ports.

17. The network of claim 16 wherein a portion of the plurality of access ports are directly coupled to the wireless switch.

18. The network of claim 16 wherein the access port further comprises a processor coupled to the transceiver and antenna selector, the processor operable to determine the one or more antennas from the plurality of antennas to couple to the transceiver.

19. The network of claim 18 wherein the processor is further configured to track a mobile the mobile unit moves from a first area covered by a first directional antenna of the plurality of antennas to a second area covered by a second directional antenna of the plurality of antennas.

20. The network of claim 16 wherein the wireless switch is configured to distribute software to each of the access ports.
